(19) United States
(12) Patent Application Publication
(10) Pub. No.: US 2010/0214294 A1
(43) Pub. Date: Aug. 26, 2010

(54) METHOD FOR TESSELLATION ON GRAPHICS HARDWARE

(75) Inventors: Chen Li, Redmond, WA (US); Jinyu Li, Redmond, WA (US); Xin Tong, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/390,328

(22) Filed: Feb. 20, 2009

(51) Int. Cl. G06T 15/50

(52) U.S. Cl. 345/423

(57) ABSTRACT

An exemplary method for tessellating a primitive of a graphical object includes receiving information for a primitive of a graphical object where the information includes vertex information and an edge factor for each edge of the primitive; based on the received information, dividing the primitive into parts where each part corresponds to at least a portion of an edge of the primitive and at least one vertex of the primitive and where each part has an association with the edge factor of the corresponding edge; for each of the parts, executing a geometry shader on a graphics processing unit (GPU) where the executing includes determining barycentric coordinates for a respective part based in part on its associated edge factor; for each of the parts, outputting the barycentric coordinates to a vertex buffer; and generating a tessellated mesh for the primitive based on the vertex information and the barycentric coordinates of the vertex buffer where the generating includes invoking a draw function of the GPU. Other methods, devices and systems are also disclosed.

### BACKGROUND

Various types of tessellations exist. For example, in mathematics, a tessellation is typically a regular tiling of polygons (in two dimensions), polyhedra (in three dimensions), or polytopes (in n dimensions). The breaking up of self-intersecting polygons into simple polygons is also called tessellation, or more properly, polygon tessellation. In graphical rendering, a broader definition may be considered that does not necessarily require “regular” tiling but rather any type of regular or irregular division of a single primitive into smaller pieces. The smaller pieces may also be considered primitives where an assemblage of the smaller primitives reproduces the outline of the initial primitive.

For graphical rendering of a scene, tessellation processes can increase scene detail. For example, a graphical artist may create a scene using coarse primitives and then input the coarse primitives into a tessellation process that generates many fine primitives for each of the coarse primitives. In this example, the initial scene of coarse primitives corresponds to a coarse mesh that may appear “blocky” or “edgy” while the tessellated scene of the fine primitives corresponds to a fine mesh that appears smooth (i.e., when compared to the rendered coarse mesh).

Various specialized computing devices have built-in tessellation functionality, sometimes referred to as “hardware tessellation”. For example, the XBOX® gaming device (Microsoft Corporation, Redmond, Wash.) has built-in tessellation functionality. An upcoming release of Microsoft's Direct3D® 11 graphics framework/DirectX® application programming interface (API) will include tessellation functionality for graphical processing units (GPUs) (i.e., so-called hardware tessellation).

In general, the Direct3D® graphics framework exposes advanced graphics capabilities of 3D graphics hardware, such as, z-buffering, anti-aliasing, alpha blending, mipmapping, atmospheric effects, and perspective-correct texture mapping. The Direct3D® graphics framework assists in delivering features such as video mapping, hardware 3D rendering in 2D overlay planes, and sprites, which provides for use of 2D and 3D graphics in interactive media titles (e.g., games, architectural tours, scientific presentations, etc.).

In the Direct3D®11 graphics framework, the tessellator is a fixed function unit, taking the outputs from a hull shader and generating the added geometry. A domain shader calculates vertex positions from tessellation data, which is passed to a geometry shader. In the Direct3D®11 graphics framework, the key primitive for the tessellator is no longer a triangle but rather a patch. A patch represents a curve or region, which can be represented by a triangle but more commonly by a quadrilateral (“quad”) in many 3D authoring applications.

An alternative to hardware tessellation is software tessellation performed on a computing device's central processing unit or units (CPUs). While tessellations can be performed on a CPU, efficiency is usually low due to ultra high volume computations that are inherent to 3D graphics. Hence, CPU-based tessellating is normally suited to non-real-time rendering only.

In general, for real-time rendering, tessellation is accomplished using a GPU with tessellation functionality (i.e., hardware tessellation). As many commercially available GPUs do not have dedicated tessellation hardware, the use of tessellation in rendering is limited. Thus, developers are limited in expressing their full creative efforts where users do not have real-time tessellation functionality.

### SUMMARY

An exemplary method for tessellating a primitive of a graphical object includes receiving information for a primitive of a graphical object where the information includes vertex information and an edge factor for each edge of the primitive; based on the received information, dividing the primitive into parts where each part corresponds to at least a portion of an edge of the primitive and at least one vertex of the primitive and where each part has an association with the edge factor of the corresponding edge; for each of the parts, executing a geometry shader on a graphics processing unit (GPU) where the executing includes determining barycentric coordinates for a respective part based in part on its associated edge factor; for each of the parts, outputting the barycentric coordinates to a vertex buffer; and generating a tessellated mesh for the primitive based on the vertex information and the barycentric coordinates of the vertex buffer where the generating includes invoking a draw function of the GPU. Other methods, devices and systems are also disclosed.

### DESCRIPTION OF DRAWINGS

Non-limiting and non-exhaustive examples are described with reference to the following figures:

FIG. 1 is a diagram of an exemplary method for tessellating an graphical object on a primitive-by-primitive basis;

FIG. 2 is a block diagram of an exemplary graphics rendering pipeline that identifies at least some resources suitable for performing the tessellating of FIG. 1;

FIG. 3 is a block diagram of an exemplary method for tessellating an input primitive of a graphical object;

FIG. 4 is a block diagram of a layered architecture for rendering graphics based on execution of a graphics application;

FIG. 5 is a diagram for illustrating an exemplary method for tessellating a primitive;

FIG. 6 is a diagram of an exemplary method for tessellating a quadrilateral primitive;

FIG. 7 is a diagram of a tessellated triangle for various edge factor values; and

FIG. 8 is a block diagram of an exemplary computing device.

### DETAILED DESCRIPTION

### Overview

An exemplary method implements tessellation processing on a GPU using geometry shader functionality of the GPU. Such an approach can provide real-time tessellation where such functionality was not previously available or available only via program execution on a CPU. A particular method splits a primitive into a number of pieces or parts. Each part is then processed by geometry shader functionality to determine barycentric coordinates sufficient to tessellate a surface defined by each part. For example, a triangle primitive may be split into six smaller triangles and a surface defined by each of the six smaller triangles may be tessellated into yet smaller triangles. In this example, the ultimate number of primitives stemming from an initial primitive depends on the number of edges of the initial primitive and edge factors for each of the edges. Overall, such an exemplary method allows for input of a course mesh and generation of a finer mesh in real-time. In turn, display of the finer mesh provides a user with more detail (e.g., whether for a single object, a scene of objects, etc.), which may enhance realism, more accurately convey of information, etc.

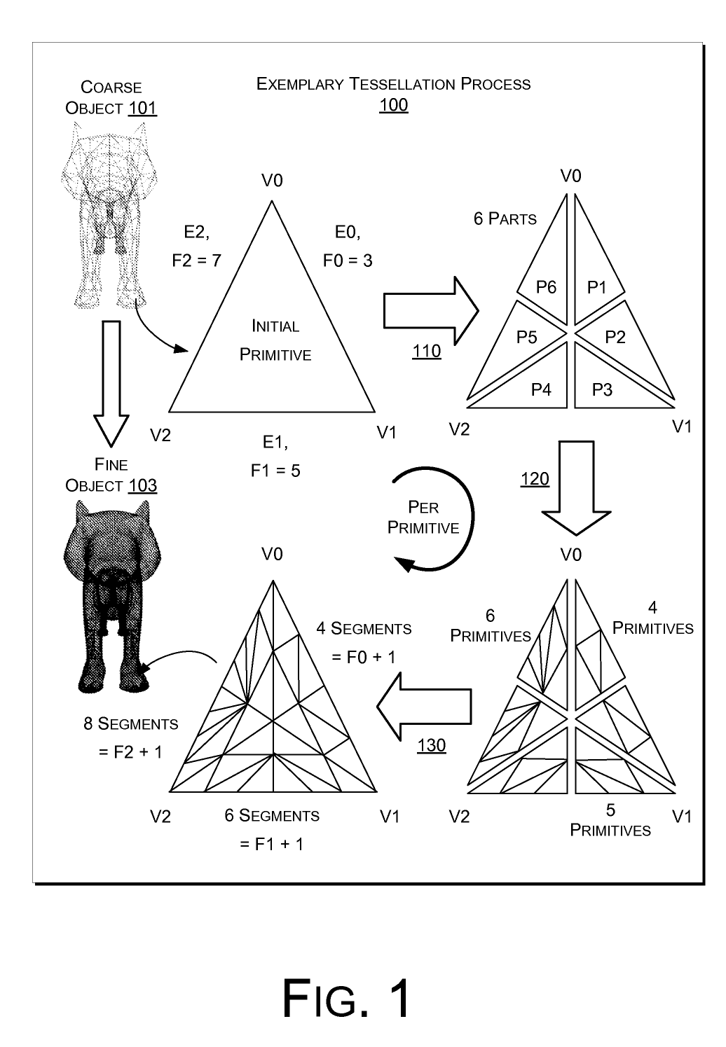

FIG. 1 shows an exemplary tessellation method 100 for tessellating primitives of a coarse mesh object 101 to generate a fine mesh object 103. In this example, the coarse mesh object 101 is a 602 triangle tiger model (“tiger.x”) from the DirectX 9.0 SDK of April 2005. The fine mesh object 103 represents a tessellated result for the coarse mesh object 101. For example, such a result may be generated by selecting each triangle of the 602 triangles and tessellating each triangle to form a finer mesh. Of course, a particular process may tessellate less than all of the original primitives of the object 101 (or other object).

According to the method 100, an initial primitive is selected with various defined parameters, including vertices V0, V1 and V2, edges E0, E1 and E2 and edge factors F0, F1 and F2. In this example, F0=3, F1=5 and F2=7. A splitting process 110 splits the initial primitive into six parts, labeled P1 through P6. Parts that share an edge of the initial primitive will be tessellated similarly to preserve the edge factor. A tessellating process 120 tessellates each of the six parts individually such that each of parts P1 and P2 include 4 primitives, each of parts P3 and P4 include 5 primitives and each of parts P5 and P6 include 6 primitives. An assembly or output process 130 provides the initial primitive in tessellated form with 30 primitives (4+4+5+5+6+6) where E0 has 4 segments (F0+1), E1 has 6 segments and E2 has 8 segments (F2+1). The edge factors may be selected to increase detail as appropriate, noting that the method 100 provides for arbitrary edge factors (e.g., floating values from 1.0 to 15.0). When repeated for multiple primitives of the coarse mesh object 101, the mesh density is greatly increased (as indicated by the fine mesh object 103).

As described, the method 100 of FIG. 1 pertains to tessellation for computer graphics, where tessellation is a process to representing a complex surface via specification of a coarser polygon mesh. As described, the coarser polygons are divided into smaller sub-polygons before rendering. This technique can be used to generate a smooth surface based on a coarse control mesh. While some GPUs have natively embedded hardware to support tessellation technique, as explained in more detail below, the method 100 can efficiently emulate hardware tessellation on, for example, Direct3D®10 graphics framework-based hardware that lacks native tessellation hardware.

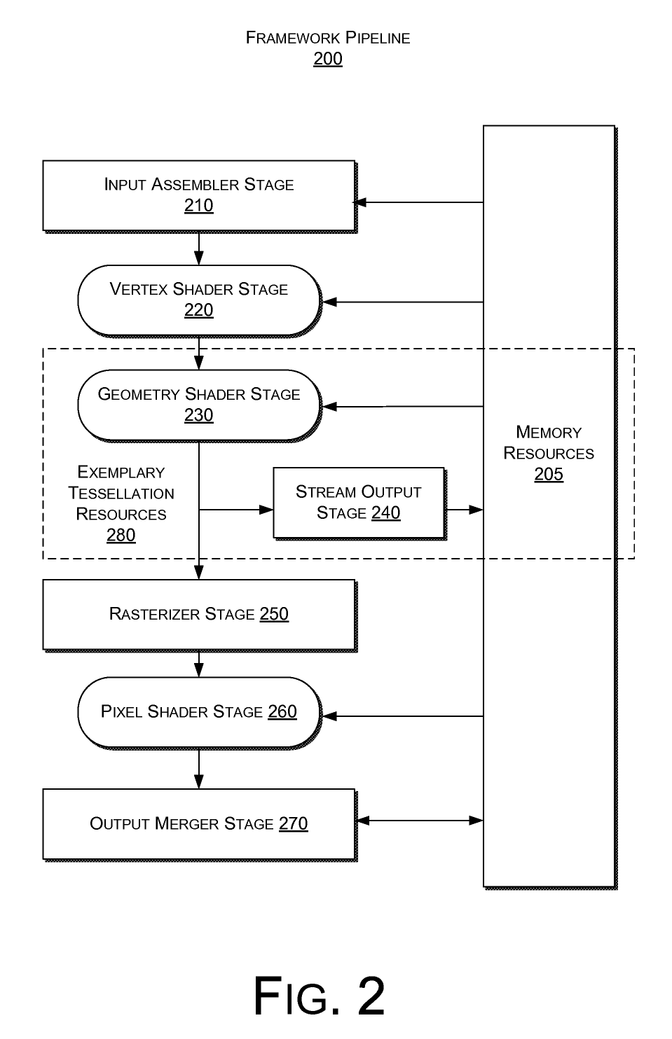

FIG. 2 shows a framework pipeline 200 for performing the method 100 of FIG. 1 using various features as exemplary tessellation resources 280. Specifically, in the example of FIG. 2, the framework pipeline 200 corresponds to that of the Direct3D®10 graphics framework. In the Direct3D®10 graphics framework, a user may create programmable shaders for the pipeline using the High Level Shading Language (HLSL). HLSL is to the Direct3D® graphics framework as the GLSL shading language is to the OpenGL® graphics framework (Silicon Graphics, Inc., Mountain View, Calif.). Further, HLSL shares aspects of the NVIDIA® Cg shading language (NVidia Corporation, Fremont, Calif.).

In general, the stages of the framework pipeline 200 can be configured using the Direct3D® graphics framework API. Stages featuring common shader cores (the rounded rectangular blocks 220, 230 and 260) are programmable using the HLSL programming language, which makes the pipeline 200 flexible and adaptable. HLSL shaders can be compiled at author-time or at runtime, and set at runtime into the appropriate pipeline stage. In general, to use a shader, a process compiles the shader, creates a corresponding shader object, and sets the shader object for use. The purpose of each of the stages is listed below.

Input-Assembler Stage 210—The input-assembler stage 210 is responsible for supplying data (triangles, lines and points) to the pipeline 200.

Vertex-Shader Stage 220—The vertex-shader stage 220 processes vertices, typically performing operations such as transformations, skinning, and lighting. A vertex shader takes a single input vertex and produces a single output vertex.

Geometry-Shader Stage 230—Conventionally, the geometry-shader stage 230 processes entire primitives where its input is a full primitive (which is three vertices for a triangle, two vertices for a line, or a single vertex for a point). In addition, each primitive can also include the vertex data for any edge-adjacent primitives, which may include at most an additional three vertices for a triangle or an additional two vertices for a line. The geometry shader stage 230 also supports limited geometry amplification and de-amplification. Given an input primitive, the geometry shader stage 230 can discard the primitive, or emit one or more new primitives.

Stream-Output Stage 240—The stream-output stage 240 is designed for streaming primitive data from the pipeline to memory on its way to a rasterizer. Data can be streamed out and/or passed into a rasterizer. Data streamed out to memory 205 can be recirculated back into the pipeline 200 (e.g., as input data or read-back from a CPU).

Rasterizer Stage 250—The rasterizer stage 250 is responsible for clipping primitives, preparing primitives for the pixel shader and determining how to invoke pixel shaders.

Pixel-Shader Stage 260—The pixel-shader stage 260 receives interpolated data for a primitive and generates per-pixel data such as color.

Output-Merger Stage 270—The output-merger stage 270 is responsible for combining various types of output data (pixel shader values, depth and stencil information) with the contents of the render target and depth/stencil buffers to generate the final pipeline result.

Conventionally, at a very high level, data enter the graphics pipeline 200 as a stream of primitives that are processed by up to as many as three of the shader stages:

The vertex shader stage 220 performs per-vertex processing such as transformations, skinning, vertex displacement, and calculating per-vertex material attributes. Conventionally, tessellation of higher-order primitives should be done before the vertex shader stage 220 executes. As a minimum, a vertex shader stage 220 must output vertex position in homogeneous clip space. Optionally, the vertex shader stage 220 can output texture coordinates, vertex color, vertex lighting, fog factors, and so on.

Conventionally, the geometry shader stage 230 performs per-primitive processing such as material selection and silhouette-edge detection, and can generate new primitives for point sprite expansion, fin generation, shadow volume extrusion, and single pass rendering to multiple faces of a cube texture.

The pixel shader stage 260 performs per-pixel processing such as texture blending, lighting model computation, and per-pixel normal and/or environmental mapping. Pixel shaders of the pixel shader stage 260 work in concert with vertex shaders of the vertex shader stage 220; conventionally, the output of the vertex shader stage 220 provides the inputs for the pixel shader stage 260.

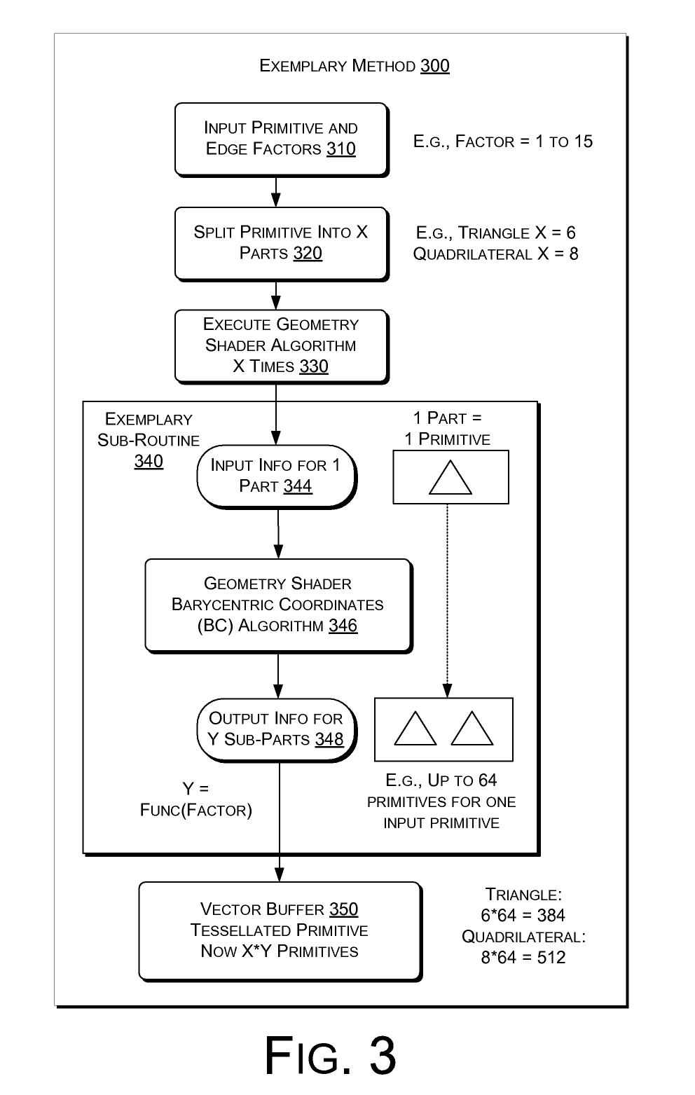

As indicated in FIG. 2, the resources 280 can be used in performing at least part of the tessellation method 100 of FIG. 1. FIG. 3 shows an exemplary method 300 in more detail with reference to the geometry shader stage 230 of FIG. 2.

In addition to allowing access to whole primitives, the geometry shader stage 230 can create new primitives on the fly. Specifically, the geometry shader in the Direct3D®10 graphics framework can read in a single primitive (with optional edge-adjacent primitives) and emit zero, one, or multiple primitives. As shown in the pipeline of FIG. 2, the output from the geometry shader stage 230 may be fed to the rasterizer stage 250 and/or to a vertex buffer in memory 205 via the stream output stage 240. Output fed to memory 205 can be expanded to individual point/line/triangle lists (e.g., in a manner as they would be passed to the rasterizer stage 250).

The geometry shader stage 230 outputs data one vertex at a time by appending vertices to an output stream object of the stream output stage 240. The topology of the streams is typically determined by a fixed declaration, choosing one of: PointStream, LineStream, or TriangleStream as the output for the geometry shader stage 230. In the Direct3D®10 graphics framework, there are three types of stream objects available, PointStream, LineStream and TriangleStream which are all templated objects. The topology of the output is determined by their respective object type, while the format of the vertices appended to the stream is determined by the template type. Execution of a geometry shader instance is atomic from other invocations, except that data added to the streams is serial. The outputs of a given invocation of a geometry shader of the geometry shader stage 230 are independent of other invocations (though ordering is respected). Conventionally, a geometry shader generating triangle strips will start a new strip on every invocation.

With respect to the method 300, barycentric coordinates are determined using a geometry shader algorithm 346 that is part of a sub-routine 340. For a reference triangle ABC, barycentric coordinates are triples of numbers corresponding to masses placed at the vertices of the reference triangle. These masses determine a point “P”, which is the geometric centroid of the three masses and identified with barycentric coordinates (i.e., a triple). Barycentric coordinates were discovered by Möbius in 1827. In the context of a triangle, barycentric coordinates are also known as areal coordinates, because the coordinates of P with respect to triangle ABC are proportional to the (signed) areas of PBC, PCA and PAB. Areal and trilinear coordinates are used for similar purposes in geometry. Barycentric or areal coordinates are useful in applications involving triangular subdomains. These make analytic integrals often easier to evaluate, and Gaussian quadrature tables are often presented in terms of areal coordinates.

The method 300 commences in an input block 310 that inputs information for a primitive including its edge factors. A split block 320 splits the primitive into X parts. For example, a triangle primitive may be split into 6 parts (e.g., 6 triangles) while a quad primitive may be split into 8 parts (e.g., four triangles and four quads). A geometry shader execution block 330 calls for execution of an exemplary sub-routine 340 a number of times that is equal to the number of parts per the split block 320.

The sub-routine 340 receives information for an input part in an input block 344, executes a geometry shader barycentric coordinate algorithm 346 and then outputs barycentric coordinates for Y sub-parts in an output block 348. The sub-routine 340, as called, provides the output 348 to a vector buffer 350. After being called X times, the vector buffer 350 contains the barycentric coordinates of the tessellated primitive, which based on the barycentric coordinates can now represented by X*Y primitives. For the Direct3D®10 graphics framework, a single primitive may be split into 64 primitives. Hence, in the Direct3D®10 graphics framework, for an input triangle primitive where X=6, the method 300 can output information for up to 384 primitives and for an input quad primitive where X=8, the method 300 can output information for up to 512 primitives. As explained, the number of output primitives is based, at least in part, on the edge factors of the initial primitive. As mentioned, the edge factors may be floating point values (e.g., 1.0, 3.5, 7.2, 12.7, etc.).

As described herein, an exemplary method for tessellating a primitive includes generating barycentric factors using a geometry shader algorithm, storing the result in a vertex buffer using a stream output stage (e.g., stream output object), and generating a tessellated mesh using a non-indexed draw call where the non-indexed draw relies on the stored barycentric factors. While the non-indexed draw is referred to as a last step, the method may be encapsulated by a non-indexed draw. For example, a program may commence with a non-indexed draw call for a primitive that, in turn, calls a geometry shader barycentric coordinate algorithm multiple times to generate barycentric factors for use in creating a fine mesh.

In the Direct3D® graphics framework, an application programming interface (API) provides for drawing non-indexed, instanced primitives (ID3D10Device::DrawInstanced) and provides for drawing non-indexed, non-instanced primitives (ID3D10Device::Draw). These interfaces are configured to submit jobs to the framework pipeline 200 of FIG. 2. The vertex data for a draw call (instanced or non-instanced) normally comes from a vertex buffer that is bound to the pipeline 200 (see, e.g., memory 205). However, it is also possible to provide the vertex data from a shader that has instanced data identified with a system-value semantic (SV_InstanceID).

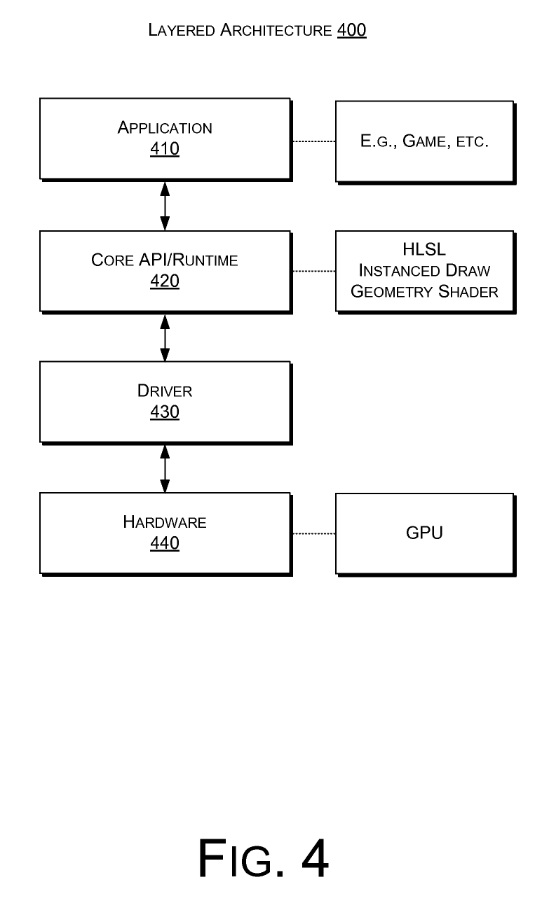

FIG. 4 shows a layered architecture 400 that includes an application 410, an API/runtime 420, a driver 430 and hardware 440. The API and runtime 420 serve as a low-overhead, thin abstraction layer above the GPU hardware 440 and provide services for allocating and modifying resources, creating views and binding them to different parts of the pipeline 200 of FIG. 2, creating shaders (e.g., for the geometry shader stage 230) and binding them to the pipeline 200, manipulating state for the non-programmable parts of the pipeline 200, initiating rendering operations, and querying information from the pipeline 200 either by retrieving statistics or the contents of resources.

In the architecture 400, commands are delivered to the pipeline 200 via a memory buffer in which it is possible to append commands. Commands are either of two classes: those that allocate or free resources and those that alter pipeline state. Accordingly, each API command calls through the runtime to the driver 430 to add hardware-specific translation of the command to the buffer. The buffer is transmitted to the hardware 440 when it is full or when another operation requires the rendering state to be synchronized (e.g., reading the contents of a render target).

In an exemplary method, an application calls a non-indexed draw interface for a primitive, which, in turn, issues a command for a geometry shader (e.g., a geometry shader object bound to a framework pipeline of a GPU) that determines barycentric coordinates for tessellating the primitive. In this method, the barycentric coordinates may be stored in a vertex buffer (e.g., via a stream output object) and then rendered, for example, as instructed per the call to the non-indexed draw interface. With respect to FIG. 4, the application 410 can call the API 420 to issue a command to execute a compiled geometry shader bound to the pipeline of the GPU hardware 440 (e.g., written in HLSL to determine barycentric coordinates for tessellating a primitive) where the command relies on the driver 430 for hardware-specific translation to access and control resources of the GPU hardware 440 (e.g., to store information to memory for use in rendering a tessellated primitive).

An exemplary method to generate tessellation factors follows. Given a triangle T with 3 vertices (V0, V1, V2), and 3 tessellation factors (F0, F1, F2) for each edge (E0, E1 and E2). The triangle T can be tessellated into N small triangles (t0, t1 . . . tn−1). N is computed as:

Ln=(Clamp(Fn, 1.0, 15.0)+1.0)2.0 (n=0,1, 2)

Lmin=Min(L0, L1, L2)

Sn=Ceil(Ln) (n=0,1, 2)

Smin=Min(S0, S1, S2)

N=6*Smin*Smin+2*(S0+S1+S2−Smin*3)

The maximum edge factor generally is 15.0, which yields maximum N equals 384. Each small triangle ti has 3 barycentric coordinates that defines an interpolation parameter for its 3 vertices. Each barycentric coordinate contains 3 floats (i.e., a triple).

As mentioned, barycentric coordinates can be generated in a geometry shader configured to emit up to 64 new primitives for one input primitive (e.g., a Direct3D®10 graphics framework geometry shader). Where the initial primitive is split into smaller parts (e.g., 6 parts for a triangle) prior to barycentric coordinate generation, this approach may generate up to 384 (=64*6) new primitives. To support larger factors, it is possible to split the input triangles into even more parts.

As already mentioned, a non-indexed draw call can be invoked that calls for running the geometry shader X times, once for each part of an initial coarser triangle T, to tessellate each part separately.

A Direct3D®10 graphics framework vertex buffer object can be created with a command (D3D10_STREAM_OUTPUT) and used to store all generated barycentric coordinates. The length in bytes of the vertex buffer is thus computed as:

N*3*2*sizeof(float) (see pseudo code below for calculation of “N”)

Specifically, in the Direct3D®10 graphics framework, it is possible to create a geometry shader object with stream output (see, e.g., the tessellation resources 280 of FIG. 2). After compiling the geometry shader, a call is made to “ID3D10Device::CreateGeometryShaderWithStreamOutput” to create a geometry shader object. Prior to this call, one should declare the steam output stage 240 input signature. This signature matches or validates the geometry shader stage 230 outputs and the stream output stage 240 inputs at the time of object creation.

In the Direct3D®10 graphics framework, it is possible to supply up to 64 declarations, one for each different type of element to be output from the stream output stage 240. The array of declaration entries describes the data layout regardless of whether only a single buffer or multiple buffers are to be bound for stream output. The stream output declaration defines the way that data is written to a buffer resource. After setting the stream output stage 240 buffer(s), data can be streamed into one or more buffers in memory for use later (e.g., for vertex data, as well as for the stream output stage 240 to stream data into).

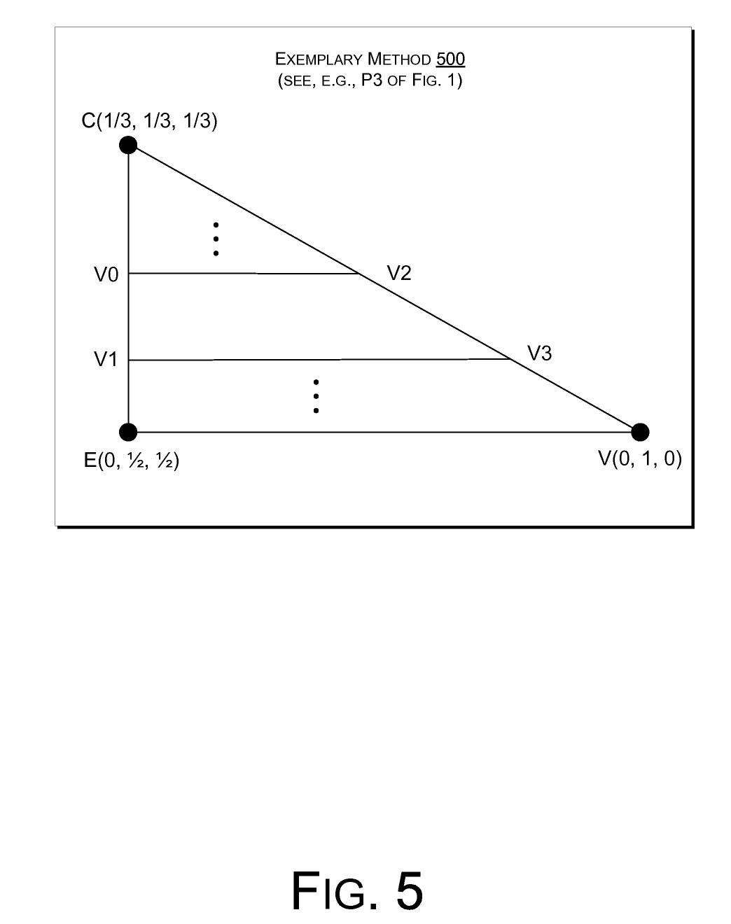

As barycentric coordinate generation of each part of the initial triangle is very similar, a single geometry shader can handle all parts. In this example, each part has 3 vertices with fixed barycentric coordinates, no matter how the triangle is going to be tessellated. As shown in a method 500 of FIG. 5, part 3 “P3” of FIG. 1 is taken as an example.

The information for P3 is as follows:

| | |
|---|---|
| V = (0, 1, 0) | One of the vertices of the input triangle T |
| E = (0, ½, ½) | Center of one of the edges of the input triangle T |
| C = (⅓, ⅓, ⅓) | Center of input triangle T |

In a geometry shader, the part will be treated as a trapezoid with 4 corner vertices to do the actual tessellation:

Va=C, Vb=C, Vc=E, Vd=V

Exemplary pseudo code used to tessellate a single part follows:

```
Procedure GenerateBarycentricCoordinatesForTriangle( PartID, F0,
F1, F2 ):
{
  Ln = ( Clamp( Fn, 1.0, 15.0 ) + 1.0 ) / 2.0 (n = 0, 1, 2)
  Lmin = Min( L0, L1, L2)
  Sn = Ceil( Ln ) (n = 0,1,2)
  Smin = Min( S0, S1, S2 )
  N = 6 * Smin * Smin + 2 * ( S0 + S1 + S2 − Smin * 3 ) (calculation
  of N)
  PointID = ( (PartID + 1 ) / 2 ) % 3
  EdgeID = PartID / 2
  Clockwise = ( 0 == (PartID & 1) )  ( part 0/2/4 is CW, part 1/3/5 is
  CCW)
  Va = Vb = C
  Vc = E
  Vd = V
```

| | |
|---|---|
| AB = 0 | (Barycentric distance between Va and Vb) |
| CD = L_{EdgeID} | (Barycentric distance between Vc and Vd) |
| BD = Lmin | (Barycentric distance between Vb and Vd) |

```
  GenerateBarycentricCoordinatesForTrapepzoid( Clockwise, Va, Vb, Vc,
Vd, AB, CD, BD, Lmin )
}
  // Note: this a general function that can also be used in quad primitives
tessellation.
Procedure GenerateBarycentricCoordinatesForTrapepzoid(
Clockwise, Va, Vb, Vc, Vd, AB, CD, BD, Lmin ):
{
  LEVELS = Ceil( BD )
  STEPx = ( Vc − Vd ) / Lmin
  STEPy = ( Vd − Vb ) / BD
  STEPxy = STEPx + STEPy
  D01 = AB
  V0 = Va
  V1 = Vb
  V2 = Vc − STEPxy * (LEVELS − 1)
  V3 = Vd − STEPy * (LEVELS − 1)
  FOR( L = 1 TO LEVELS) DO
  {
    IF( 1 == L )
      D23 = CD
    ELSE
      D23 = Lmin − (LEVELS − 1)
    S01 = Ceil( D01 )
    S23 = Ceil( D23 )
    FOR( I = 0 TO (S01−1) )
    {
      T0 = Lerp( V0, V1, I/D01 )
      T2 = Lerp( V2, V3, I/D23 )
      T3 = Lerp( V2, V3, (I+1)/D23 )
      IF( I == (S01 − 1 ) )
        T1 = V1
      ELSE
        T1 = Lerp( V0, V1, (I+1)/D01 )
      GenerateTriangle(Clockwise, T0, T2, T3 )
      GenerateTriangle(Clockwise, T0, T3, T1 )
    }
    FOR( I = S0 TO (S23−1) )
    {
      T2 = Lerp( V2, V3, I/D23 )
      IF( I == (S23−1) )
        T3 = V3
      ELSE
        T3 = Lerp( V2, V3, (I+1)/D23 )
      GenerateTriangle( Clockwise, V1, T2, T3 )
    }
    D01 = D23
    V0 = V2i
    V1 = V3
    V2 += STEPxy
    V3 += STEPy
  }
} // END of the procedure
Procedure GenerateTriangle( Clockwise, V0, V1, V2 ):
{
  IF( Clockwise )
  {
    // Note: this is a geometry shader intrinsic function in the
Direct3D ® 10 graphics framework that can generate a new primitive.
    GenerateNewPrimitive( V0, V1, V2 )
  }
  ELSE
  {
    GenerateNewPrimitive( V0, V2, V1 )
  }
}
```

An exemplary method to generate a tessellated mesh follows, given the barycentric coordinate buffer generated as described above.

Call a Direct3D®10 graphics framework non-indexed draw command:

ID3D10Device::Draw(N, 0); (refer to preceding pseudocode for calculation of N)

Hence, an exemplary method can use a geometry shader stage of a framework pipeline of a GPU to tessellate an initial input primitive to generate N primitives. In turn, a draw command may then be used to render the N primitives.

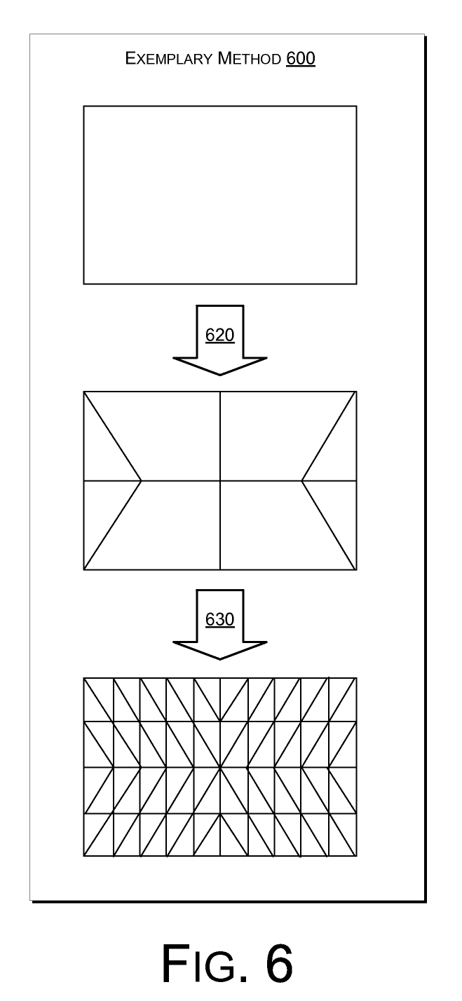

FIG. 6 shows an exemplary method 600 for tessellating a quad primitive. In general, the method 600 shares aspects of the method 100 of FIG. 1 for tessellating a triangle primitive. As indicated in a process 620, a quad is split into 8 trapezoids (e.g., including four triangles). As the exemplary algorithm (see, e.g., the method 500 of FIG. 5) accounts for quadrilaterals (four vertices, where redundancy may occur), each trapezoid can be tessellated.

As described herein, an exemplary method for tessellating a primitive of a graphical object includes receiving information for a primitive of a graphical object where the information includes vertex information and an edge factor for each edge of the primitive; based on the received information, dividing the primitive into parts where each part corresponds to at least a portion of an edge of the primitive and at least one vertex of the primitive and where each part has an association with the edge factor of the corresponding edge; for each of the parts, executing a geometry shader on a graphics processing unit (GPU) where the executing includes determining barycentric coordinates for a respective part based in part on its associated edge factor; for each of the parts, outputting the barycentric coordinates to a vertex buffer; and generating a tessellated mesh for the primitive based on the vertex information and the barycentric coordinates of the vertex buffer where the generating includes invoking a draw function of the GPU. In such an exemplary method, the geometry shader may be a compiled geometry shader associated with an application programming interface (API) that exposes functionality of the GPU, for example, an API of the Direct3D®10 graphics framework.

As mentioned, a primitive of a graphics object may be a triangle and divided into parts (e.g., six or another number of parts). In some examples, a primitive of a graphics object is a quadrilateral and divided into parts (e.g., eight or another number of parts). As shown in FIG. 6, a quadrilateral may be divided into triangles and quadrilaterals (e.g., four triangles and four quadrilaterals).

In a particular implementation, with respect to edge factors, an edge factor may be an odd number (e.g., from one to fifteen) and correspond to dividing an edge into a corresponding number of segments (e.g., from two to sixteen segments for edge factors of one to fifteen, respectively).

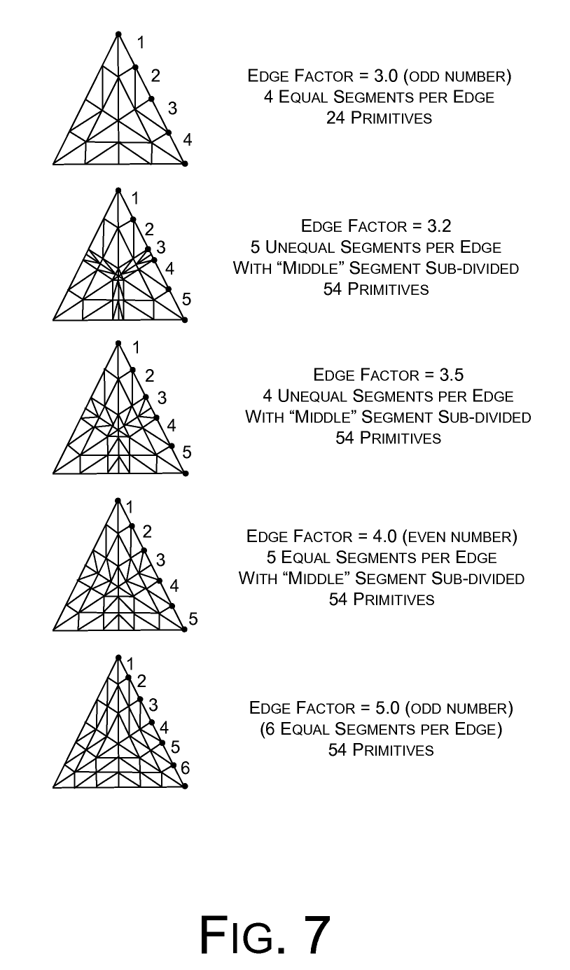

In another implementation, to allow for smoother transitions, an edge factor can be any floating point value (e.g., between 1.0 and 15.0). Use of floating point values allows for smooth transitions between a coarse mesh and a dense mesh. FIG. 7 shows various floating point value edge factors. Specifically, FIG. 7 shows edge factors of 3.0, 3.2, 3.5, 4.0 and 5.0, which demonstrate how a continuous transition of tessellation from an edge factor of 3.0 to an edge factor of 5.0. Further, FIG. 7 shows the number of edge segments (noting a “sub-divided” segment for edge factors 3.2, 3.5 and 4.0) along with the number of primitives. As indicated in the examples of FIG. 7, floating point values allow for unevenness in primitives compared to integer values.

As to outputting information, an exemplary method may include issuing a stream output command to a GPU that configures the GPU such that barycentric coordinates from a geometry shader of the GPU are output to a vertex buffer of the GPU. In various examples, a stream output command generates a vertex buffer object in an object based framework for the GPU.

As mentioned, dividing a primitive into parts may include representing each of the parts as a trapezoid. Sometime after execution of a geometry shader function to generate barycentric coordinates, another geometry shader function may be invoked to define new primitives. For example, for each input primitive, multiple “new” primitives may be defined by a geometry shader function. As mentioned, a draw function of a GPU (e.g., a non-index draw function) may be used to draw the new primitives. Where multiple primitives are processed for a graphics object, which collectively represent a coarse mesh of the graphics object, an exemplary method can generate a finer mesh for the graphics object. Various operations of an exemplary method may stem from execution of one or more processor-readable media that include processor-executable instructions to perform tasks such as dividing a primitive into parts, executing a geometry shader to generate barycentric coordinates for a part and the outputting barycentric coordinates to a vertex buffer.

As described herein, an exemplary graphics processing unit (GPU) includes a vertex buffer; an executable module configured to divide a primitive of a graphics object into parts where a primitive has edges, vertexes and an edge factor for each of the edges and where each part corresponds to at least a portion of one of the edges and at least one of the vertexes and where each part has an association with the edge factor of the corresponding edge; a geometry shader configured to determine barycentric coordinates for a respective part based in part on the associated edge factor of the respective part; an output module configured to output, for each of the parts, the barycentric coordinates from the geometry shader to the vertex buffer; and a draw module configured to draw a tessellated mesh for a primitive based on its vertexes and the barycentric coordinates of the parts of the primitive as stored in the vertex buffer. Such a GPU may include modules exposable via an application programming interface (API) for the graphics processing unit, for example, an API associated with the Direct3D®10 graphics framework.

As described herein, an exemplary system includes a processor; memory; and a graphical processing unit that includes a vertex buffer and control logic to divide a primitive of a graphics object into parts where a primitive has edges, vertexes and an edge factor for each of the edges and where each part corresponds to at least a portion of one of the edges and at least one of the vertexes and where each part has an association with the edge factor of the corresponding edge; to determine barycentric coordinates for a respective part based in part on the associated edge factor of the respective part; to output, for each of the parts, the barycentric coordinates to the vertex buffer; and to draw a tessellated mesh for a primitive based on its vertexes and the barycentric coordinates of the parts of the primitive as stored in the vertex buffer. Such a system may include a software interface (e.g., an API) to expose the control logic of the graphics processing unit. Such a system may include a graphics application in the memory and executable by the processor to thereby instruct the graphics processor unit to render graphics where the graphics processing unit renders tessellated graphics.

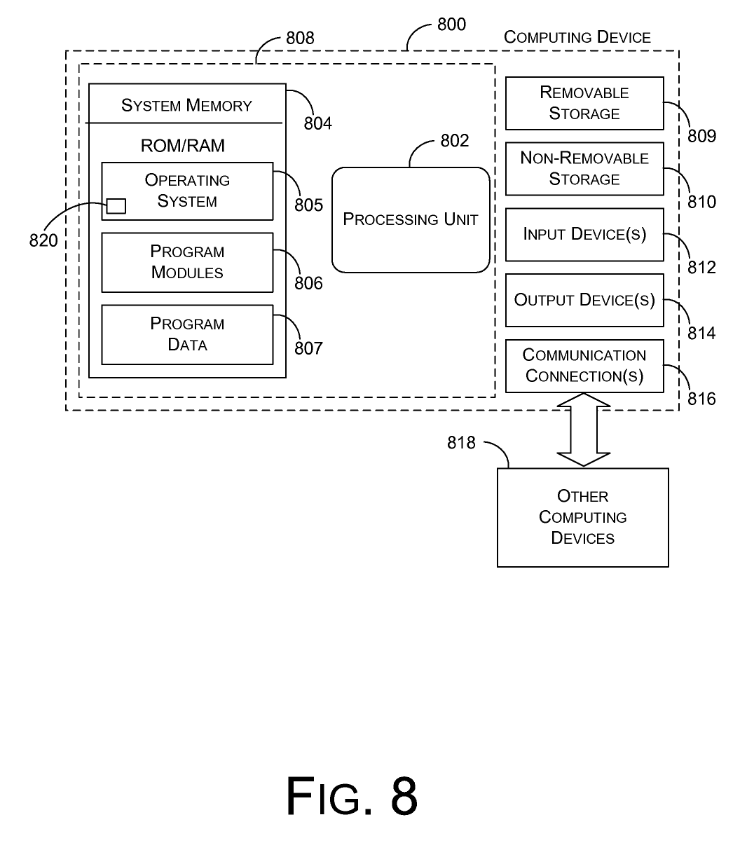

FIG. 8 illustrates an exemplary computing device 800 that may be used to implement various exemplary components and in forming an exemplary system.

In a very basic configuration, computing device 800 typically includes at least one processing unit 802 and system memory 804. Depending on the exact configuration and type of computing device, system memory 804 may be volatile (such as RAM), non-volatile (such as ROM, flash memory, etc.) or some combination of the two. System memory 804 typically includes an operating system 805, one or more program modules 806, and may include program data 807. The operating system 805 include a component-based framework 820 that supports components (including properties and events), objects, inheritance, polymorphism, reflection, and provides an object-oriented component-based application programming interface (API), such as that of the .NET™ Framework marketed by Microsoft Corporation, Redmond, Wash. The device 800 is of a very basic configuration demarcated by a dashed line 808. Again, a terminal may have fewer components but will interact with a computing device that may have such a basic configuration.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by removable storage 809 and non-removable storage 810. Computer storage media may include volatile and nonvolatile, removable and non-removable media implemented in any method or technology for storage of information, such as computer readable instructions, data structures, program modules, or other data. System memory 804, removable storage 809 and non-removable storage 810 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of device 800. Computing device 800 may also have input device(s) 812 such as keyboard, mouse, pen, voice input device, touch input device, etc. Output device(s) 814 such as a display, speakers, printer, etc. may also be included. These devices are well known in the art and need not be discussed at length here. An output device 814 may be a graphics card or graphical processing unit (GPU). In an alternative arrangement, the processing unit 802 may include an “on-board” GPU. In general, a GPU can be used in a relatively independent manner to a computing device's CPU. For example, a CPU may execute a gaming application where rendering visual scenes occurs via a GPU without any significant involvement of the CPU in the rendering process. Examples of GPUs include but are not limited to the Radeon® HD 3000 series and Radeon® HD 4000 series from ATI (AMD, Inc., Sunnyvale, Calif.) and the Chrome 430/440GT GPUs from S3 Graphics Co., Ltd. (Freemont, Calif.).

Computing device 800 may also contain communication connections 816 that allow the device to communicate with other computing devices 818, such as over a network. Communication connections 816 are one example of communication media. Communication media may typically be embodied by computer readable instructions, data structures, program modules, or other data forms. By way of example, and not limitation, communication media includes wired media such as a wired network or direct-wired connection, and wireless media such as acoustic, RF, infrared and other wireless media.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for tessellating a primitive of a graphical object, the method comprising:
receiving information for a primitive of a graphical object wherein the information comprises vertex information and an edge factor for each edge of the primitive;
based on the received information, dividing the primitive into parts wherein each part corresponds to at least a portion of an edge of the primitive and at least one vertex of the primitive and wherein each part comprises an association with the edge factor of the corresponding edge;
for each of the parts, executing a geometry shader on a graphics processing unit (GPU) wherein the executing comprises determining barycentric coordinates for a respective part based in part on its associated edge factor;
for each of the parts, outputting the barycentric coordinates to a vertex buffer; and
generating a tessellated mesh for the primitive based on the vertex information and the barycentric coordinates of the vertex buffer wherein the generating comprises invoking a draw function of the GPU.

2. The method of claim 1 wherein the geometry shader comprises a compiled geometry shader associated with an application programming interface (API) that exposes functionality of the GPU

3. The method of claim 2 wherein the API comprises an API of the Direct3D®10 graphics framework.

4. The method of claim 1 wherein the primitive of the graphics object comprises a triangle and wherein the dividing divides the triangle into six parts.

5. The method of claim 1 wherein the primitive of the graphics object comprises a quadrilateral and wherein the dividing divides the quadrilateral into eight parts.

6. The method of claim 5 wherein the parts comprise four triangles and four quadrilaterals.

7. The method of claim 1 wherein an edge factor comprises an odd number from one to fifteen and correspond to dividing an edge into two to sixteen segments, respectively.

8. The method of claim 1 wherein the outputting comprises issuing a stream output command to the GPU that outputs the barycentric coordinates from the geometry shader of the GPU to the vertex buffer of the GPU.

9. The method of claim 8 wherein the stream output command generates a vertex buffer object in an object based framework for the GPU.

10. The method of claim 1 wherein the dividing comprises representing each of the parts as a trapezoid.

11. The method of claim 1 wherein the executing comprises executing a geometry shader function to define new primitives.

12. The method of claim 1 wherein the draw function of the GPU comprises a non-index draw function.

13. The method of claim 1 further comprising repeatedly performing the method for other primitives of the graphics object, which collectively represent a coarse mesh of the graphics object, to generate a finer mesh for the graphics object.

14. One or more processor-readable media comprising processor-executable instructions to perform the dividing, the executing and the outputting of the method of claim 1.

15. A graphics processing unit comprising:
a vertex buffer;
an executable module configured to divide a primitive of a graphics object into parts wherein a primitive comprises edges, vertexes and an edge factor for each of the edges and wherein each part corresponds to at least a portion of one of the edges and at least one of the vertexes and wherein each part comprises an association with the edge factor of the corresponding edge;
a geometry shader configured to determine barycentric coordinates for a respective part based in part on the associated edge factor of the respective part;
an output module configured to output, for each of the parts, the barycentric coordinates from the geometry shader to the vertex buffer; and
a draw module configured to draw a tessellated mesh for a primitive based on its vertexes and the barycentric coordinates of the parts of the primitive as stored in the vertex buffer.

16. The graphics processing unit of claim 15 wherein the modules are exposable via an application programming interface (API) for the graphics processing unit.

17. The graphics processing unit of claim 16 wherein the API comprises an API associated with the Direct3D®10 graphics framework.

18. A system comprising:
a processor;
memory; and
a graphics processing unit that comprises a vertex buffer and control logic to divide a primitive of a graphics object into parts wherein a primitive comprises edges, vertexes and an edge factor for each of the edges and wherein each part corresponds to at least a portion of one of the edges and at least one of the vertexes and wherein each part comprises an association with the edge factor of the corresponding edge; to determine barycentric coordinates for a respective part based in part on the associated edge factor of the respective part; to output, for each of the parts, the barycentric coordinates to the vertex buffer; and to draw a tessellated mesh for a primitive based on its vertexes and the barycentric coordinates of the parts of the primitive as stored in the vertex buffer.

19. The system of claim 18 further comprising a software interface to expose the control logic of the graphics processing unit.

20. The system of claim 18 further comprising a graphics application in the memory and executable by the processor to thereby instruct the graphics processor unit to render graphics wherein the graphics processing unit renders tessellated graphics.
